(19) United States
(12) Patent Application Publication
(10) Pub. No.: US 2010/0150647 A1
(43) Pub. Date: Jun. 17, 2010

(54) PIPE FIXTURE

(75) Inventors: Rong-Mou BAO, Shenzhen City (CN); Ga-Lei HU, Shenzhen City (CN); De-Bing WANG, Shenzhen City (CN); Zhi-wei WANG, Shenzhen City (CN); Chi-Chung LIU, Tu-Cheng (TW); Jian-Long XING, Shenzhen City (CN); Chun-Nan OU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/482,365

(22) Filed: Jun. 10, 2009

(30) Foreign Application Priority Data
Dec. 12, 2008 (CN) 200810306203.8

(51) Int. Cl. F16L 41/00

(52) U.S. Cl. 403/196

(57) ABSTRACT

A pipe fixture includes a main body including a receiving hole and a first through hole communicating with the receiving hole, a first positioning pin received in a first end portion of the first through hole including a screw hole and a first pressing portion, and a knob including a screw rod suitable to engage with the screw hole of the first positioning pin, a knob top and a step portion. When the knob extends through the second end portion of the first through hole and is screwed into the screw hole, the first positioning pin moves and presses the pipe so as to fix the pipe, and when the knob is unscrewed from the screw hole, the first positioning pin moves away from the pipe so that the pipe is released.

### BACKGROUND

1. Technical Field

The disclosure relates to pipe fixtures.

2. Description of Related Art

Referring to FIG. 8, a commonly used pipe fixture 10 is used for fixing a pipe 11. The pipe fixture 10 includes a receiving hole 14 to receive the pipe 11, and a slot 101 in communication with the receiving hole 14. A width of the slot 101 can be adjusted to adjust a radius of the receiving hole 14 to lock or unlock the pipe 11. A pair of screws 12 is used to adjust the width of the slot 101, resulting in inconvenience of assembly or disassembly of the pipe 11.

Therefore, a need exists in the industry to overcome the described limitations.

### BRIEF DESCRIPTION OF THE DRAWINGS

FIG. 1 is an exploded, isometric perspective view of a pipe fixture in accordance with a first embodiment of the disclosure.

FIG. 2 is a cross sectional view of a main body taken along line II-II of FIG. 1.

FIG. 3 is an assembled view of FIG. 1.

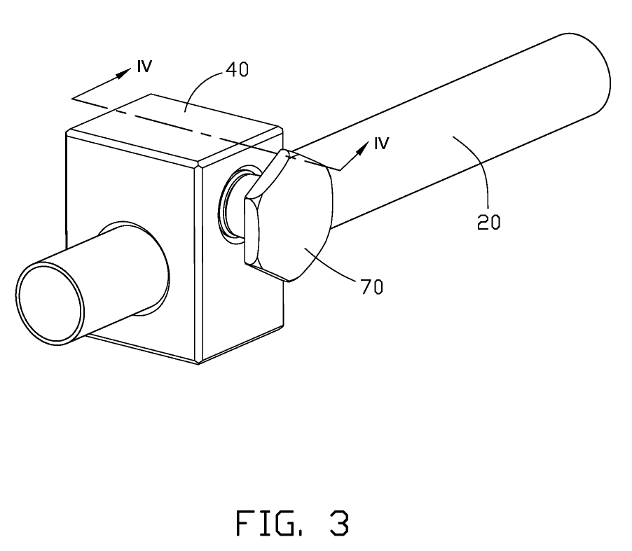

FIG. 4 is a cross sectional view taken along line IV-IV of FIG. 3.

FIG. 5 is a front view of a first positioning pin of FIG. 1.

FIG. 6 is a cross-sectional view of a pipe fixture in accordance with a second embodiment of the disclosure.

FIG. 7 is a cross sectional view of a main body of FIG. 6.

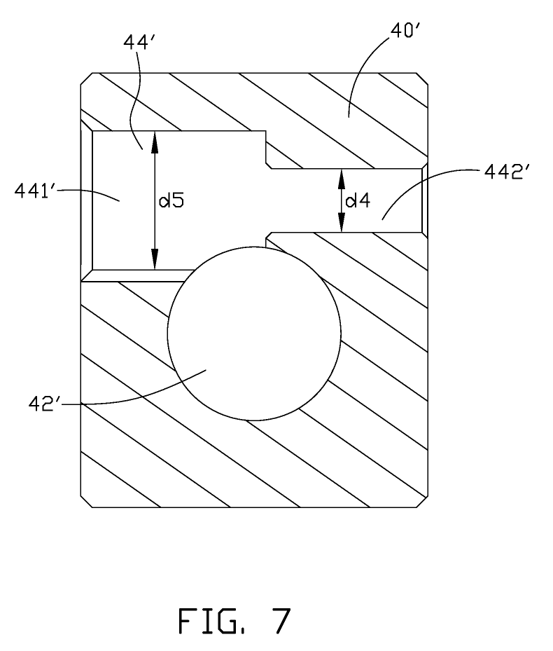

FIG. 8 is an isometric perspective view of a commonly used pipe fixture.

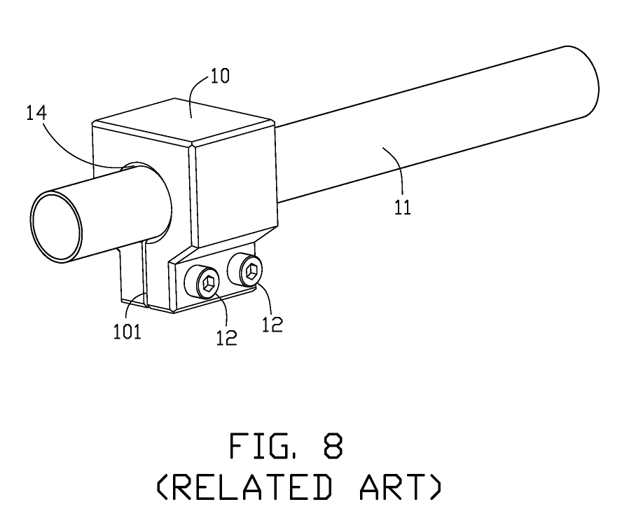

### DETAILED DESCRIPTION

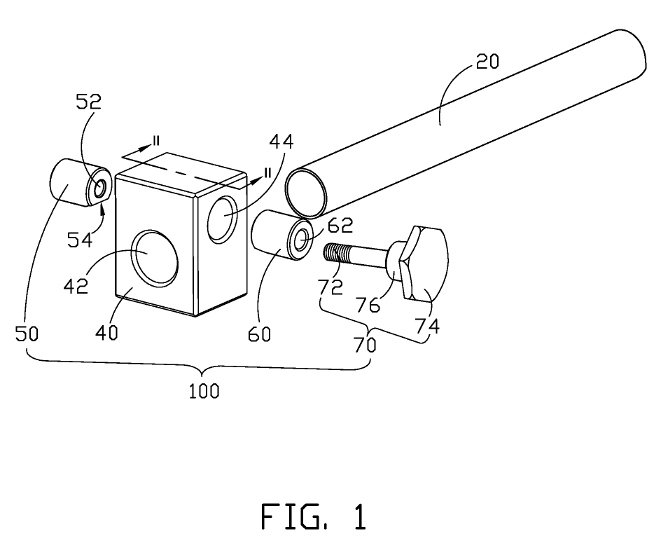

FIG. 1 shows an exploded, isometric perspective view of a pipe fixture 100 in accordance with a first embodiment of the disclosure. The pipe fixture 100 is provided for fixing a pipe 20. The pipe fixture 100 includes a main body 40, a first positioning pin 50, a second positioning pin 60, and a knob 70.

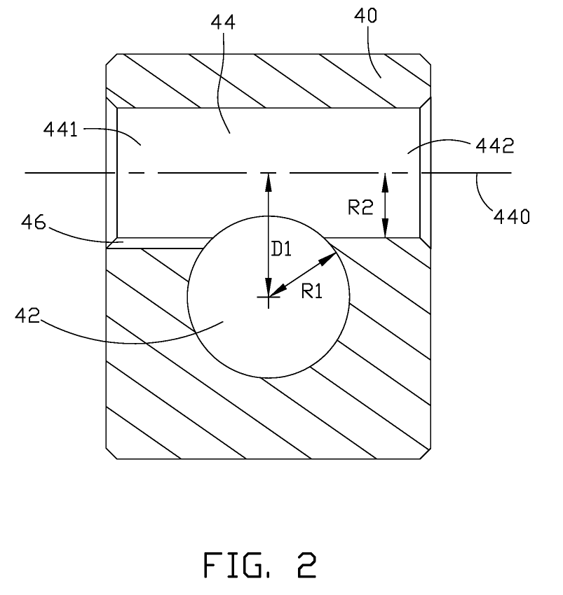

FIG. 2 is a cross sectional view of the main body 40 of FIG. 1. The main body 40 defines a receiving hole 42 to receive the pipe 20, a first through hole 44 communicating with the receiving hole 42, and a slot 46 communicating with the first through hole 44 to limit the first positioning pin 50 to rotate relative to the main body 40 after assembly. An axis 440 of the first through hole 44 is perpendicular to an axis (not labeled) of the receiving hole 42. The radius R1 of the receiving hole 42 and a radius R2 of the first through hole 44 are each less than a distance D1 between the axis 440 of the first through hole 44 and the axis of the receiving hole 42.

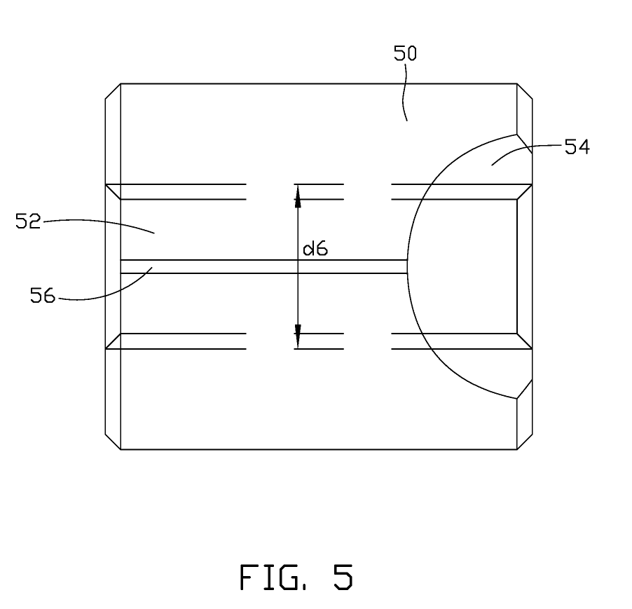

Referring to FIG. 2 and FIGS. 4-5, the first positioning pin 50 is received in a first end portion 441 of the first through hole 44. The first positioning pin 50 includes a screw hole 52 defined in a middle of the first positioning pin 50, a first pressing portion 54 located at an end portion of the first positioning pin 50, and a projection 56 extending from an outer wall of the first positioning pin 50. In the illustrated embodiment, the first pressing portion 54 is a substantially arc-shaped concave surface. After assembly, the pressing portion 54 abuts against an outer wall of the pipe 20, and the projection 56 matches with the slot 46 of the main body 40 to limit the first positioning pin 50 to rotate relative to the main body 40.

The second positioning pin 60 is received in a second end portion 442 of the first through hole 44. The second positioning pin 60 includes a second through hole 62 defined in a middle of the second positioning pin 60 (referring to FIG. 1), and a second pressing portion 64 located at an end portion of the second positioning pin 60. In the illustrated embodiment, the second pressing portion 64 is a substantially arc-shaped concave surface. A diameter d3 of the second through hole 62 is substantially equal to a diameter d6 of the screw hole 52. After assembly, an axis (not labeled) of the second through hole 62 aligns with an axis (not labeled) of the screw hole 52. The second pressing portion 64 abuts against the outer wall of the pipe 20, and is opposite to the first pressing portion 54.

In the illustrated embodiment, the first through hole 44 is circular, and the first positioning pin 50 and the second positioning pin 60 are columniform.

Alternatively, the first through hole 44 may be polygonal, for example, in having the shape of a quadrangle, hexagon, or octagon. Correspondingly, the first positioning pin 50 and the second positioning pin 60 are polygonal. Thus, after assembly, the first positioning pin 50 and the second positioning pin 60 cannot rotate relative to the main body 40, so that the slot 46 and the projection 56 can be omitted. In other words, the shapes of the first positioning pin 50 and the second positioning pin 60 can be changed in light of the shape of the first through hole 44.

The knob 70 includes a screw rod 72 suitable to engage with the screw hole 52 of the first positioning pin 50, a knob top 74, and a step portion 76 located between the screw rod 72 and the knob top 74 to limit the knob 70 moving along the first through hole 44 related to the main body 40. In the illustrated embodiment, an outer diameter d1 of the step portion 76 is less than an outer diameter d2 of the second positioning pin 60 and greater than the diameter d3 of the second through hole 62.

In assembly, the pipe 20 is inserted into the receiving hole 42. The first positioning pin 50 is received in the first end portion 441, and the second positioning pin 60 is received in the second end portion 442. The screw rod 72 of the knob 70 extends through the second though hole 62 and is screwed into the screw hole 52.

In use, the knob top 74 is rotated in a first direction with the first positioning pin 50 and the second positioning pin 60 moving toward each other, and the first pressing portion 54 and the second pressing portion 64 pressing the outer wall of the pipe 20, so that the pipe 20 is fixed firmly by the pipe fixture 100. In this position, the step portion 76 abuts against the second positioning pin 60.

While the knob top 74 is rotated in a second direction opposite to the first direction, the first positioning pin 50 and the second positioning pin 60 move away from each other with the screw rod 72 of the knob 70 unscrewing from the screw hole 52 of the first positioning pin 50, so that the pipe 20 is released and can be pulled out of the pipe fixture 100.

The pipe 20 can be fixed to or released from the main body 40 by rotating the knob 70 rather than screws, resulting in convenient assembly or disassembly of the pipe 20.

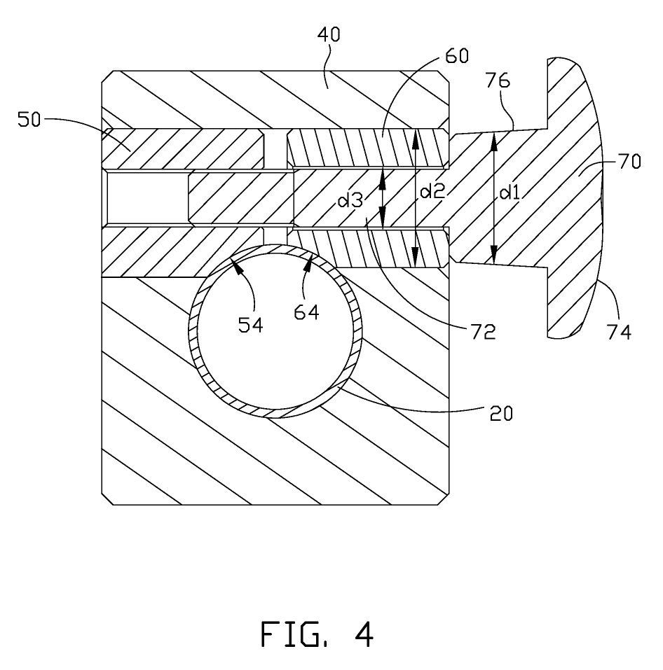

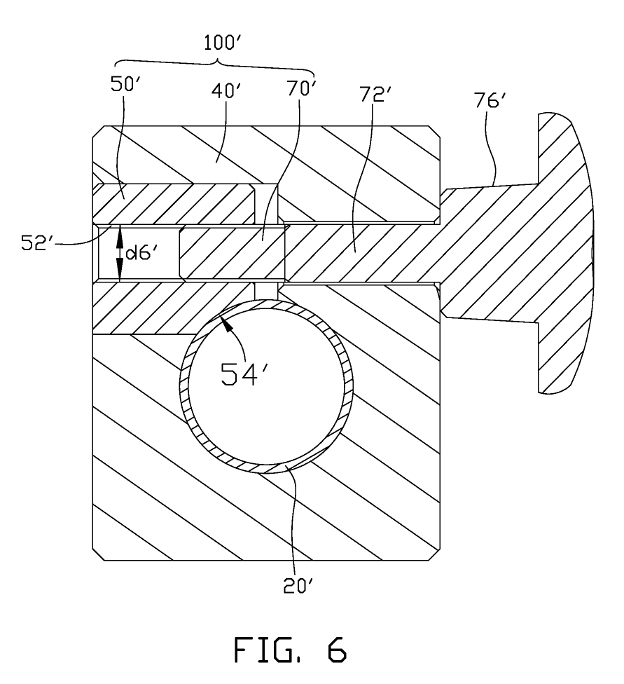

FIG. 6 shows a cross sectional view of a pipe fixture 100′ in accordance with a second embodiment of the disclosure. The pipe fixture 100′ has the same configuration and can substantially perform the same function as the pipe fixture 100 shown in FIG. 4, differing only in that the main body 40′ includes a ladder-shaped first through hole 44′ including a first end portion 441′ and a second end portion 442′. In the illustrated embodiment, a diameter d4 of a second end portion 442′ of the first through hole 44′ is less than a diameter d5 of a first end portion 441′ of the first through hole 44′, and is equal to a diameter d6′ of a screw hole 52′ of a positioning pin 50′.

In use, a knob 70′ is rotated in a first direction with the positioning pin 50′ moving toward the second end portion 442′ of the first through hole 44′ and a pressing portion 54′ of the positioning pin 50 pressing the outer wall of a pipe 20′, so that the pipe 20′ is fixed firmly by the pipe fixture 100′. In this position, a step portion 76′ of the knob 70′ abuts against the main body 40′. While the knob 70′ is rotated in a second direction opposite to the first direction, the positioning pin 50′ moves away from the second end portion 442′ of the first through hole 44′ with the knob screw 72′ of the knob 70′ disengaging from the first positioning pin 50′, so that the pipe 20′ is released from the pipe fixture 100′.

While the exemplary embodiments have been described, it should be understood that it has been presented by way of example only and not by way of limitation. The breadth and scope of the disclosure should not be limited by the described exemplary embodiments, but only in accordance with the following claims and their equivalent.

What is claimed is:

1. A pipe fixture for fixing a pipe, comprising:
a main body comprising a receiving hole to receive the pipe, and a first through hole comprising a first end portion and a second end portion, the first through hole being in communication with the receiving hole, wherein an axis of the first through hole is perpendicular to an axis of the receiving hole, and wherein a radius of the first end portion of the first through hole and a radius of the receiving hole each are less than a distance between the axis of the first through hole and that of the receiving hole;
a first positioning pin received in the first end portion of the first through hole and defining a screw hole and a first pressing portion located at an end portion of the first positioning pin; and
a knob comprising a screw rod suitable to engage with the screw hole of the first positioning pin, a knob top and a step portion located between the screw rod and the knob top;
wherein when the knob extends through the second end portion of the first through hole and is screwed into the screw hole, the first positioning pin moves towards the knob top and presses the pipe so as to fix the pipe, and
when the knob is unscrewed from the screw hole, the first positioning pin moves away from the pipe so that the pipe is released.

2. The pipe fixture as claimed in claim 1, wherein the pipe fixture comprises a second positioning pin received in the second end portion of the first through hole and defining a second through hole;
wherein when the knob extends through the second through hole and is screwed into the screw hole, the step portion abuts against the second positioning pin and the second position pin subsequently presses the pipe.

3. The pipe fixture as claimed in claim 2, wherein the first through hole is circular, and the first positioning pin and the second positioning pin are columniform correspondingly.

4. The pipe fixture as claimed in claim 3, wherein the main body defines a slot communicating with the first through hole, and the first positioning pin comprises a projection matching with the slot to limit the first positioning pin to rotate relative to the main body.

5. The pipe fixture as claimed in claim 2, wherein the first through hole is polygonal, and the first positioning pin and the second positioning pin are correspondingly polygonal.

6. The pipe fixture as claimed in claim 1, wherein the first through hole is a ladder-shaped hole, a radius of the first end portion of the first through hole is greater than that of the second end portion;
wherein when the knob extends through the second end portion of the first through hole and is screwed into the screw hole, the step portion abuts against main body.

7. A pipe fixture for fixing a pipe, comprising:
a main body comprising a receiving hole to receive the pipe, and a first through hole comprising a first end portion and a second end portion, the first through hole being in communication with the receiving hole, wherein an axis of the first through hole is perpendicular to an axis of the receiving hole, and wherein a radius of the first through hole and a radius of the receiving hole each are less than a distance between the axis of the first through hole and that of the receiving hole;
a first positioning pin received in a first end portion of the first through hole and defining a screw hole and a first pressing portion located at an end portion of the first positioning pin; a second positioning pin received in a second end portion of the first through hole and defining a second through hole; and
a knob comprising a screw rod suitable to engage with the screw hole of the first positioning pin, a knob top and a step portion located between the screw rod and the knob top;
wherein when the knob extends through the second through hole and is screwed into the screw hole, the step portion of the knob abuts against the second positioning pin, and the first positioning pin and the second positioning pin move towards each other and press the pipe so as to fix the pipe, and
when the knob is unscrewed from the screw hole, the first positioning pin and the second positioning pin move away from each other so that the pipe is released.

8. The pipe fixture as claimed in claim 7, wherein the first through hole is circular, and the first positioning pin and the second positioning pin are columniform correspondingly.

9. The pipe fixture as claimed in claim 8, wherein the main body defines a slot communicating with the first through hole, and the first positioning pin comprises a projection matching with the slot to limit the first positioning pin to rotate relative to the main body.

10. The pipe fixture as claimed in claim 7, wherein the first through hole is polygonal, and the first positioning pin and the second positioning pin are correspondingly polygonal.

11. A pipe fixture for fixing a pipe, comprising:
a main body comprising a receiving hole to receive the pipe, and a ladder-shaped through hole comprising a first end portion and a second end portion, the ladder-shaped through hole being in communication with the receiving hole, wherein a diameter of the second end portion is less than a diameter of the first end portion, and an axis of the through hole is perpendicular to an axis of the receiving hole, and wherein a radius of the receiving hole and a radius of the first end portion of the first through hole each are less than a distance between the axis of the through hole and that of the receiving hole;
a positioning pin receiving in a first end portion of the through hole and defining a screw hole and a pressing portion located at an end portion of the positioning pin; and
a knob comprising a screw rob suitable to engage with the screw hole of the first positioning pin, a knob top and a step portion located between the screw rob and the knob top;
wherein when the knob extends through the second end portion of the through hole and is screwed into the screw hole, the step portion abuts against the main body and the positioning pin moves and presses the pipe so as to fix the pipe, and
when the knob is unscrewed from the screw hole, the positioning pin moves away from the pipe so that the pipe is released.

12. The pipe fixture as claimed in claim 11, wherein the though hole is circular, and the positioning pin is columniform correspondingly.

13. The pipe fixture as claimed in claim 12, wherein the main body comprises a slot communicating with the through hole and the positioning pin comprises a projection matching with the slot to limit the positioning pin to rotate relative to the main body.

14. The pipe fixture as claimed in claim 11, wherein the through hole is polygonal and the positioning pin is correspondingly polygonal.
